(19) United States
(12) Patent Application Publication
(10) Pub. No.: US 2011/0110297 A1
(43) Pub. Date: May 12, 2011

(54) WIRELESS BROADBAND SUBSCRIBER EQUIPMENT AND COMMUNICATION SYSTEM WITH NETWORK QUALITY MANAGEMENT CAPABILITY, AND COMMUNICATION METHOD THEREOF

(75) Inventor: Cheng-Yuan Chuang, Yangmei Township (TW)

(73) Assignee: GEMTEK TECHNOLOGY CO., LTD., Hukou (TW)

(21) Appl. No.: 12/794,548

(22) Filed: Jun. 4, 2010

(30) Foreign Application Priority Data
Nov. 9, 2009 (TW) 098137919

(51) Int. Cl. H04W 4/00

(52) U.S. Cl. 370/328

(57) ABSTRACT

A wireless broadband subscriber equipment with network quality management capability includes a parsing unit, a quality-of-service (QoS) controller, and a grant controller. The parsing unit receives a session signal containing session-establishing information, and parses the session signal to obtain a control signal. The QoS controller sends to a base station a QoS request signal corresponding to the control signal. The grant controller receives a response of the base station to the QoS request signal, is configured to forward the session signal to an intended recipient of the session signal when the response of the base station indicates that the base station is available to establish a session conforming to the QoS request signal, and to send a busy notification to a sender of the session signal when the response of the base station indicates that the base station is unavailable to establish the session conforming to the QoS request signal.

### CROSS-REFERENCE TO RELATED APPLICATION

This application claims priority of Taiwanese Application No. 098137919, filed on Nov. 9, 2009.

### BACKGROUND OF THE INVENTION

1. Field of the Invention

The present invention relates to a wireless broadband subscriber equipment, a communication system, and a communication method; more particularly to a wireless broadband subscriber equipment and communication system with network quality management capability, and a communication method thereof.

2. Description of the Related Art

Referring to FIG. 1, current broadband internet access technologies are categorized into wired connection and wireless connection. In the case of wired connection, a user terminal 711 (e.g., personal computer) can be connected to the internet via a T1, a xDSL, or a cable modem 712.

In the case of wireless connection, a user terminal 81 can be connected to the internet via a Worldwide Interoperability for Microwave Access (WiMAX) device. WiMAX was developed to provide high-speed, quality-of-service (QoS) enabled wireless broadband “last mile” connections between end users and operator networks.

The protocols and specifications of WiMAX are specified in the IEEE 802.16 standards, among which, the IEEE 802.16d standard is for fixed network access, and the IEEE 802.16e standard is an amendment to the IEEE 802.16d standard to add mobility. Accordingly, further referring to FIG. 1, mobile user terminals 811 are connected to the base station 80 using the IEEE 802.16e standard, and each of fixed user terminals 81 of different zones 9 is connected to the base station 80 via a subscriber station 82 using the IEEE 802.16d standard.

Nevertheless, conventional wireless broadband subscriber equipments are unable to achieve high-quality multimedia streaming because quality-of-service (QoS) control is implemented only in the operator network, and not at the user end. Hence, without knowing the resource usage of the base station 80, the user terminals 711, 81, 811 may compromise quality of other established sessions by sending more session establishment requests when there is insufficient resource at the base station 80.

### SUMMARY OF THE INVENTION

Therefore, an object of the present invention is to provide a wireless broadband subscriber equipment with network quality management capability.

Accordingly, a wireless broadband subscriber equipment with network quality management capability of this invention is capable of communicating with a base station. The wireless broadband subscriber equipment includes a parsing unit, a quality-of-service (QoS) controller, and a grant controller.

The parsing unit is for receiving a session signal that contains session-establishing information, and is for parsing the session signal to obtain a control signal corresponding to resources of the base station required for establishing a session conforming to the session-establishing information.

The QoS controller is for sending to the base station a QoS request signal corresponding to the control signal obtained by the parsing unit for reserving resources of the base station required for establishing the session.

The grant controller is for receiving a response of the base station to the QoS request signal. The grant controller is configured to forward the session signal to an intended recipient of the session signal when the response of the base station indicates that the base station is available to establish a session conforming to the QoS request signal. The grant controller is further configured to send a busy notification to a sender of the session signal when the response of the base station indicates that the base station is unavailable to establish the session conforming to the QoS request signal.

Another object of the present invention is to provide a communication system with network quality management capability.

Accordingly, a communication system with network quality management capability of this invention includes a base station, a user terminal, and a subscriber station.

The subscriber station is capable of communicating with the base station and the user terminal, and includes a parsing unit, a quality-of-service (QoS) controller, and a grant controller.

The parsing unit is for receiving from one of the base station and the user terminal a session signal that contains session-establishing information, and is for parsing the session signal to obtain a control signal corresponding to resources of said base station required for establishing a session conforming to the session-establishing information of the session signal. The QoS controller is for sending to the base station a QoS request signal corresponding to the control signal obtained by the parsing unit for requesting resources of said base station required for establishing the session. The grant controller is for receiving a response of the base station to the QoS request signal. The grant controller is configured to forward the session signal to the other of the base station and the user terminal when the response of the base station indicates that the base station is available to establish a session conforming to the QoS request signal. The grant controller is further configured to send a busy notification to said one of the base station and the user terminal when the response of the base station indicates that the base station is unavailable to establish the session conforming to the QoS request signal.

Yet another object of the present invention is to provide a communication method with network quality management method to be implemented using a wireless broadband subscriber equipment and a base station capable of communicating with each other. The communication method of this invention includes the steps of:

configuring the wireless broadband subscriber equipment to receive a session signal that contains session-establishing information, and to parse the session signal to obtain a control signal corresponding to resources of the base station required for establishing a session conforming to the session-establishing information of the session signal;

configuring the wireless broadband subscriber equipment to send to the base station a QoS request signal corresponding to the control signal obtained by the wireless broadband subscriber equipment for requesting resources of said base station required for establishing the session; and

configuring the wireless broadband subscriber equipment

to receive a response of the base station to the QoS request signal,

to forward the session signal to an intended recipient of the session signal when the response of the base station indicates that the base station is available and has reserved resource required to establish a session conforming to the QoS request signal, and

to send a busy notification to a sender of the session signal when the response of the base station indicates that the base station is unavailable to establish the session conforming to the QoS request signal.

In summary, the wireless broadband subscriber station, communication system, and communication method of the present invention deny establishment of a session when a base station is unavailable to establish the session conforming to a quality-of-service (QoS) request.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a scenario in which a plurality of user terminals are connected to a base station;

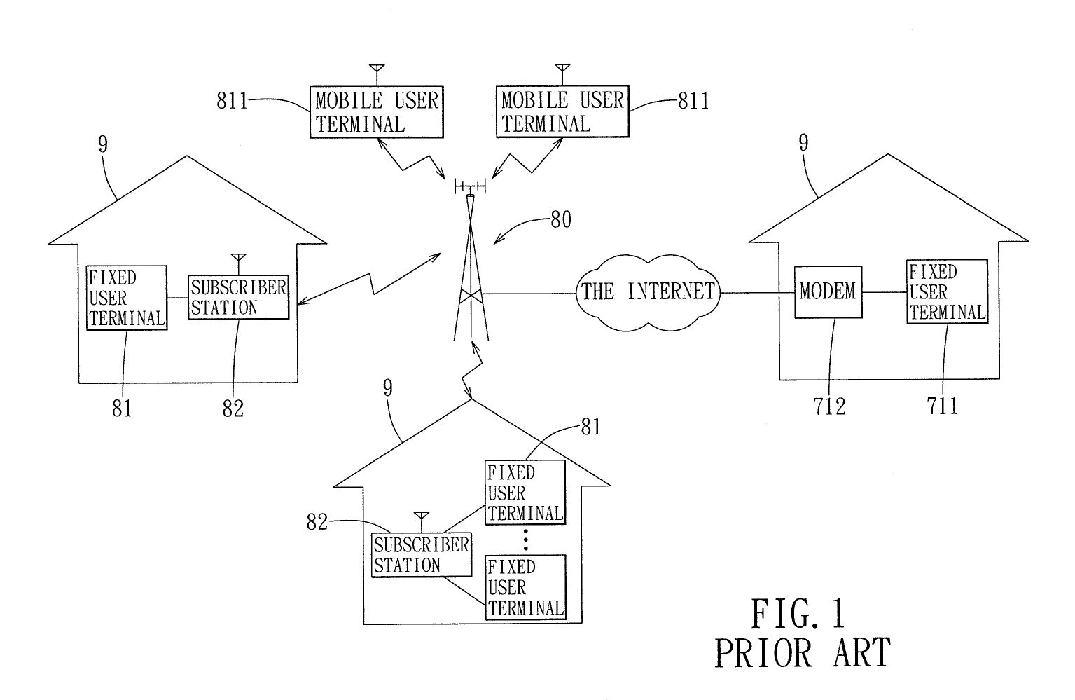

FIG. 2 is a schematic system block diagram of a wireless broadband subscriber equipment of the preferred embodiment of a communication system according to the present invention;

FIG. 3 is a schematic system block diagram of a management device configured in a processor of the wireless broadband subscriber equipment;

FIG. 4 is a flowchart illustrating procedure of a successful session establishment according to a communication method of the present invention;

FIG. 5 is a flowchart illustrating procedure of a denied session establishment according to the communication method of the present invention; and

FIG. 6 is a flowchart illustrating procedure of another denied session establishment according to the communication method of the present invention.

### DETAILED DESCRIPTION OF THE PREFERRED EMBODIMENT

It is to be noted that the term “session” as used hereinafter can mean a real-time streaming of at least one of sound, video, or image. Furthermore, establishment of the session is based on the Session Initiation Protocol (SIP), the Media Gateway Control Protocol (MGCP), or the H.323 protocol.

In the IEEE 802.16e standard, there are four quality-of-service (QoS) classes.

Unsolicited Grant Service (UGS) provides real-time, constant-bandwidth service. Data streams of UGS have constant packet length and periodic transmission intervals.

Real-Time Polling Service (rtPS) provides real-time, variable-bandwidth service. Data streams of rtPS have variable packet length and periodic transmission intervals. Typical applications of rtPS are Voice over IP (VoIP) and MPEG streaming.

Non-Real-Time Polling Service (nrtPS) provides non-real-time, variable-bandwidth service. Data streams of nrtPS have variable packet length and non-periodic transmission intervals. Applications of nrtPS are usually delay-insensitive and do not require a constant bit rate. An example of nrtPS application is FTP file transfer.

Best Effort (BE) provides service for which no minimum service quality is required. Data streams of BE are handled with the lowest priority in relation to the other classes. Typical applications of BE include E-mail and Short Messaging Service (SMS).

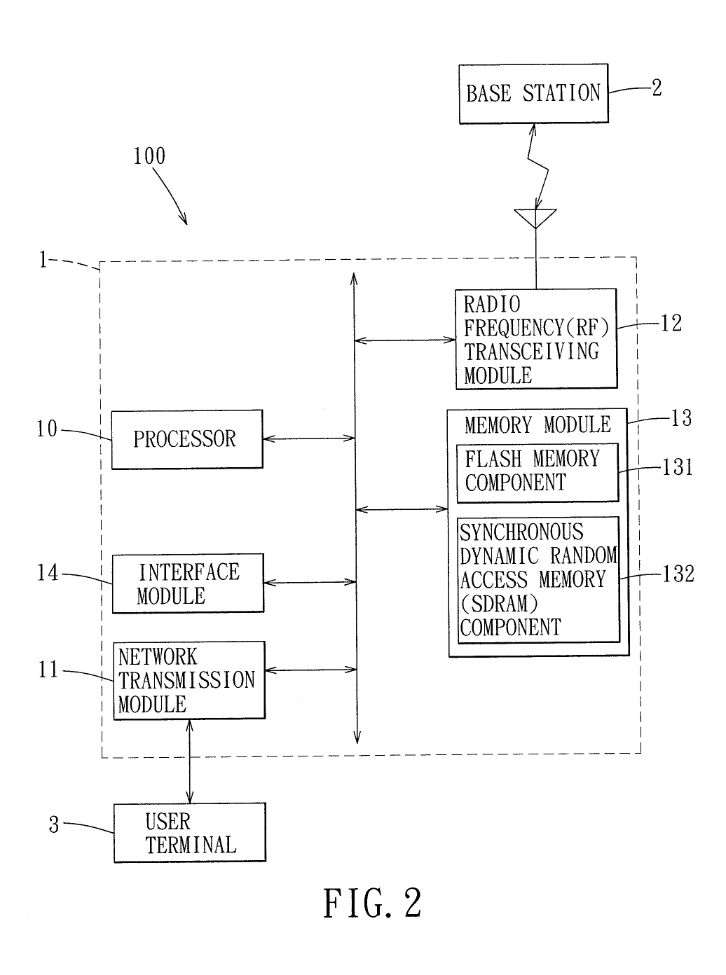

Referring to FIG. 2, a communication system 100 of the preferred embodiment of the present invention includes a subscriber station (SS) 1, a base station (BS) 2, and at least one user terminal 3. The subscriber station 1 communicates with, and serves as a medium for one-way or two-way transmissions, between the base station 2 and the user terminal 3. In the present embodiment, the subscriber station 1 and the user terminal 3 are integrated and embodied as a VoIP phone. However, in other embodiments of the present invention, the subscriber station 1 and the user terminal 3 can be integrated and embodied as a network video conferencing device, a network facsimile, or any other wireless multimedia streaming devices.

The subscriber station 1 includes a processor 10, a network transmission module 11, a radio frequency (RF) transmission module 12, a memory module 13, and an interface module 14 that communicate with each other via a bus.

The processor 10 is responsible for coordinating operations of the other modules of the subscriber station 1.

The network transmission module 11 is for establishing a wired connection between the subscriber station 1 and the user terminal 3. In an embodiment, the network transmission module 11 includes an ethernet network physical interface (not shown) for communicating with the user terminal 3 via an RJ45 cable.

The RF transmission module 12 is for establishing a wireless connection between the subscriber station 1 and the base station 2. The radio frequency (RF) transceiving module 12 includes an RF transceiving component (not shown).

The memory module 13 is for storing data to be transacted, and includes a flash memory component 131 and a synchronous dynamic random access memory (SDRAM) component 132.

The interface module 14 is for testing or providing basic controls of the subscriber station 1, and includes interfaces such as SPI, serial, or JTAG.

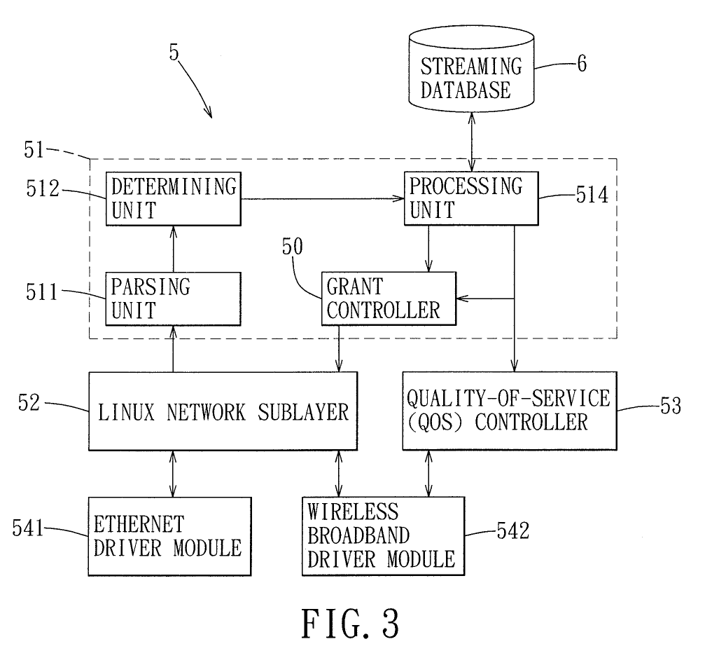

Referring to FIG. 3, the processor 10 of the subscriber station 1 is configured with a management device 5 including an application module 51, a Linux network sub-layer 52, a quality-of-service (QoS) controller 53, an ethernet driver module 541, a wireless broadband driver module 542, and a streaming database 6.

The application module 51 is located in the user space, and communicates with the Linux network sub-layer 52, the QoS controller 53, and the streaming database 6. The ethernet driver module 541 and the wireless broadband driver module 542 are located in the kernel space. The application module 51 communicates with the ethernet driver module 541 via the Linux network sub-layer 52, and with the wireless broadband driver module 542 via the Linux network sub-layer 52 and the QoS controller 53.

Furthermore, the ethernet driver module 541 serves as a communication medium between the Linux network sub-layer 52 and the network transmission module 11. The wireless broadband driver module 542 serves as a communication medium between the RF transceiving module 12 and each of the Linux network sub-layer 52 and the QoS controller 53.

The application module 51 includes a parsing unit 511, a determining unit 512, and a processing unit 514.

The parsing unit 511 is configured to receive from the Linux network sub-layer 52 a session signal (e.g., SIP INVITE/SDP) that contains information for establishing a session. The parsing unit 511 is further configured to parse the session signal to obtain a control signal. The determining unit 512 is configured to determine a bandwidth required for establishing the session according to the control signal. The processing unit 514 is configured to control operation of the QoS controller 53 such that the QoS controller 53 generates a QoS request signal (e.g., “QoS Request: rtPS 92 kbps”) corresponding to the required bandwidth determined by the determining unit 512. The QoS request signal is transmitted from the QoS controller 53 to the RF transceiving module 12 via the wireless broadband driver module 542, and is then transmitted wirelessly by the RF transceiving module 12 to the base station 2 for reserving resource of the base station 2 required to establish the session.

The application module 51 further includes a grant controller 50 that is configured to receive a response of the base station 2 to the QoS request signal, and to forward the session signal to an intended recipient of the session signal when the response of the base station 2 indicates that the base station 2 is available to establish the session conforming to the QoS request signal. The grant controller 50 is further configured to send a busy notification to a sender of the session signal when the response of the base station 2 indicates that the base station 2 is unavailable to establish the session conforming to the QoS request signal.

In the present embodiment, the grant controller 50 is a transparent proxy server and is for controlling multimedia session signals sent between the user terminal 3 and a remote terminal (e.g., a multimedia streaming server). The session signals are analyzed and stored temporarily in the transparent proxy server until a response is received from the base station 2.

The procedures of successful session establishment and denied session establishment according to the communication method of this invention are described hereinafter. It is to be noted that the user terminal 3 and the subscriber station 1 can be integrated and embodied as a wireless broadband subscriber equipment.

### Successful Session Establishment:

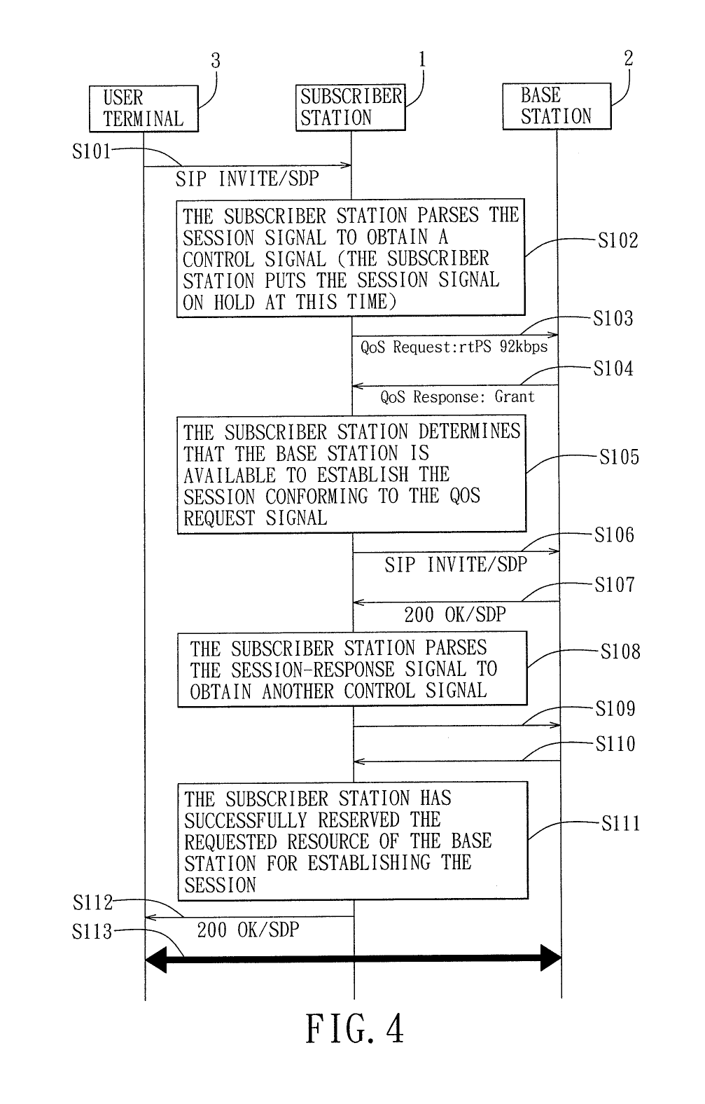

Referring to FIG. 4, the procedure of successful session establishment includes the steps of:

S101) the user terminal 3 generates a session signal (e.g., SIP INVITE/SDP) and sends the session signal to the subscriber station 1;

S102) the subscriber station 1 parses the session signal to obtain a control signal (the subscriber station 1 puts the session signal on hold at this time);

S103) the subscriber station 1 sends a QoS request signal (e.g., QoS Request: rtPS 92 kbps), that corresponds to the control signal, to the base station 2 so as to reserve resource of the latter;

S104) the base station 2 accepts the session establishment request, reserves resource thereof, and sends a response (e.g., QoS Response: Grant) to the subscriber station 1;

S105) the subscriber station 1 determines that the base station 2 is available to establish the session conforming to the QoS request signal;

S106) the subscriber station 1 forwards the session signal (SIP INVITE/SDP) to the base station 2;

S107) the subscriber station 1 receives a session-response signal (e.g., 200 OK/SDP) from the base station 2;

S108) the subscriber station 1 parses the session-response signal (200 OK/SDP) to obtain another control signal;

S109) the subscriber station 1 sends another QoS request signal, that corresponds to said another control signal, to the base station 2 for adjusting the reserved resource of the base station 2;

S110) the base station 2 adjusts the reserved resource thereof and sends another response signal to the subscriber station 1;

S111) the subscriber station 1 has successfully reserved the requested resource of the base station 2 for establishing the session;

S112) the subscriber station 1 forwards the session-response signal (200 K/SDP) to the user terminal 3; and

S113) the session is established with the requested QoS parameters, and the base station 2 and the user terminal 3 start multimedia streaming.

### Denied Session Establishment (Session Initiated by User Terminal)

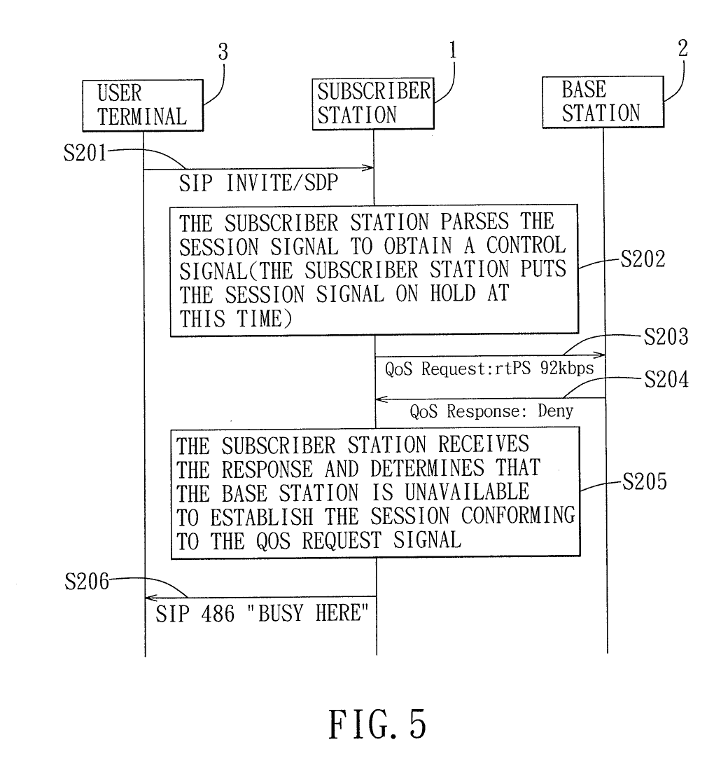

Referring to FIG. 5, the procedure of a denied session establishment includes the steps of:

S201) the user terminal 3 generates a session signal (e.g., SIP INVITE/SDP) and sends the session signal to the subscriber station 1;

S202) the subscriber station 1 parses the session signal to obtain a control signal (the subscriber station 1 puts the session signal on hold at this time);

S203) the subscriber station 1 sends a QoS request signal (e.g., QoS Request: rtPS 92 kbps), that corresponds to the control signal, to the base station 2 so as to reserve resource of the latter;

S204) the base station denies the session establishment request and sends a response (e.g., QoS Response: Deny) to the subscriber station 1;

S205) the subscriber station 1 receives the response and determines that the base station 2 is unavailable to establish the session conforming to the QoS request signal; and

S206) the subscriber station 1 sends a busy notification (e.g., SIP 486 “BUSY HERE”) to the user terminal 3

### Denied Session Establishment (Session not Initiated by User Terminal)

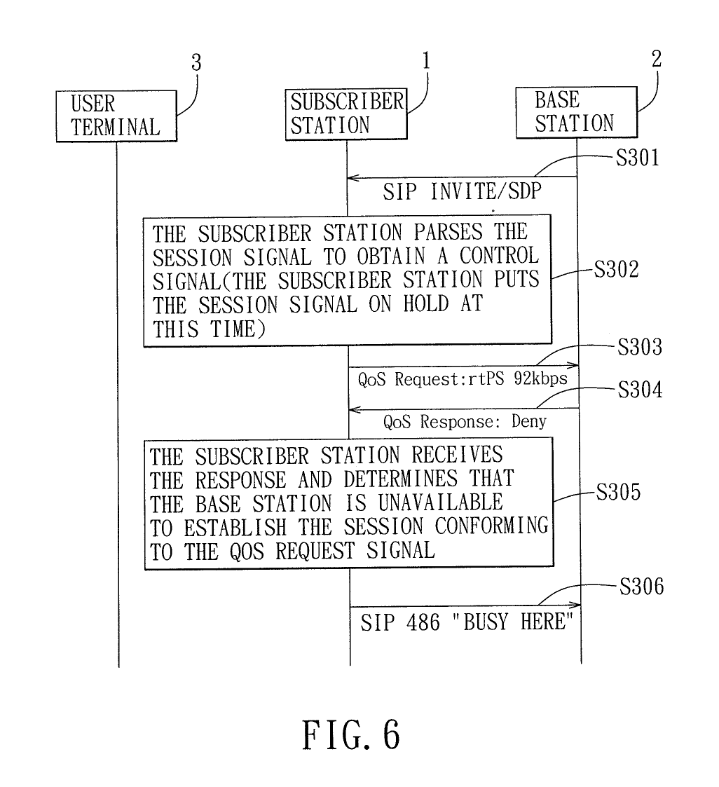

Referring to FIG. 6, the procedure of another denied session establishment includes the steps of:

S301) the base station 2 forwards a session signal (e.g. SIP INVITE/SDP) to the subscriber station 1;

S302) the subscriber station 1 parses the session signal to obtain a control signal (the subscriber station 1 puts the session signal on hold at this time);

S303) the subscriber station 1 sends a QoS request signal (e.g., QoS Request: rtPS 92 kbps), that corresponds to the control signal, to the base station 2 so as to reserve resource of the latter;

S304) the base station 2 denies the session establishment request and sends a response (e.g., QoS Response: Deny) to the subscriber station 1;

S305) the subscriber station 1 receives the response and determines that the base station 2 is unavailable to establish the session conforming to the QoS request signal; and

S306) the subscriber station 1 sends a busy notification (e.g., SIP 486 “BUSY HERE”) to the base station 2.

In summary, the subscriber station 1, communication system 100, and communication method of the present invention deny establishment of a session when a base station is unavailable to establish the session conforming to a quality-of-service (QoS) request.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wireless broadband subscriber equipment with network quality management capability, said wireless broadband subscriber equipment being capable of communicating with a base station and comprising:
a parsing unit for receiving a session signal that contains session-establishing information, and for parsing the session signal to obtain a control signal corresponding to resources of the base station required for establishing a session conforming to the session-establishing information;
a quality-of-service (QoS) controller for sending to the base station a QoS request signal corresponding to the control signal obtained by said parsing unit for reserving resources of the base station required for establishing the session; and
a grant controller for receiving a response of the base station to the QoS request signal, said grant controller being configured to forward the session signal to an intended recipient of the session signal when the response of the base station indicates that the base station is available to establish a session conforming to the QoS request signal, said grant controller being further configured to send a busy notification to a sender of the session signal when the response of the base station indicates that the base station is unavailable to establish the session conforming to the QoS request signal.

2. The wireless broadband subscriber equipment as claimed in claim 1, wherein said grant controller is a transparent proxy server.

3. The wireless broadband subscriber equipment as claimed in claim 1, being one of a network phone, a network video conferencing device, and a network facsimile device.

4. The wireless broadband subscriber equipment as claimed in claim 1, wherein the session signal is a signal of one of the session initiation protocol, the media gateway control protocol, and the H.323 protocol, and the session-establishing information is defined using the session description protocol.

5. A communication system with network quality management capability, comprising:
a base station;
a user terminal; and
a subscriber station capable of communicating with said base station and said user terminal, said subscriber station including
a parsing unit for receiving from one of said base station and said user terminal a session signal that contains session-establishing information, and for parsing the session signal to obtain a control signal corresponding to resources of said base station required for establishing a session conforming to the session-establishing information of the session signal,
a quality-of-service (QoS) controller for sending to said base station a QoS request signal corresponding to the control signal obtained by said parsing unit for requesting resources of said base station required for establishing the session, and
a grant controller for receiving a response of said base station to the QoS request signal, said grant controller being configured to forward the session signal to the other of said base station and said user terminal when the response of said base station indicates that said base station is available to establish a session conforming to the QoS request signal, said grant controller being further configured to send a busy notification to said one of said base station and said user terminal when the response of said base station indicates that said base station is unavailable to establish the session conforming to the QoS request signal.

6. The communication system as claimed in claim 5, wherein said grant controller is a transparent proxy server.

7. The communication system as claimed in claim 5, wherein said subscriber station and said user terminal are integrated for implementation as one of a network phone, a network video conferencing device, and a network facsimile device.

8. The communication system as claimed in claim 5, wherein the session signal is a signal of one of the session initiation protocol, the media gateway control protocol, and the H.323 protocol, and the session-establishing information is defined using the session description protocol.

9. A communication method with network quality management to be implemented using a wireless broadband subscriber equipment and a base station capable of communicating with each other, the communication method comprising the steps of:
configuring the wireless broadband subscriber equipment to receive a session signal that contains session-establishing information, and to parse the session signal to obtain a control signal corresponding to resources of the base station required for establishing a session conforming to the session-establishing information of the session signal;
configuring the wireless broadband subscriber equipment to send to the base station a QoS request signal corresponding to the control signal obtained by the wireless broadband subscriber equipment for requesting resources of said base station required for establishing the session; and
configuring the wireless broadband subscriber equipment
to receive a response of the base station to the QoS request signal,
to forward the session signal to an intended recipient of the session signal when the response of the base station indicates that the base station is available and has reserved resource required to establish a session conforming to the QoS request signal, and
to send a busy notification to a sender of the session signal when the response of the base station indicates that the base station is unavailable to establish the session conforming to the QoS request signal.

10. The communication method as claimed in claim 9, further comprising the steps of:
configuring the intended recipient of the session signal to send a session-response signal to the wireless broadband subscriber equipment in response to the session signal;
configuring the wireless broadband subscriber equipment to parse the session-response signal, that contains session-establishing information, to obtain another control signal corresponding to resources of said base station required for establishing the session conforming to the session-establishing information of the session-response signal;
configuring the wireless broadband subscriber equipment to send to the base station another QoS request signal corresponding to said another control signal obtained by the wireless broadband subscriber equipment for adjusting the reserved resource of the base station;
configuring the base station to adjust the reserved resource thereof in response to said another QoS request signal; and
configuring the wireless broadband subscriber equipment to communicate with the base station.

11. A communication method with network quality management to be implemented using a wireless broadband subscriber equipment and a base station capable of communicating with each other, the communication method comprising the steps of:
configuring one of the wireless broadband subscriber equipment and the base station to generate a session signal for establishing a session;
configuring the wireless broadband subscriber equipment to parse the session signal to obtain a control signal corresponding to resources of the base station required for establishing the session conforming to the session-establishing information of the session signal;
configuring the wireless broadband subscriber equipment to send to the base station a QoS request signal corresponding to the control signal obtained by the wireless broadband subscriber equipment for requesting resources of said base station required for establishing the session; and
configuring the wireless broadband subscriber equipment to receive a response of the base station to the QoS request signal, and to deny establishment of the session when the response of the base station indicates that the base station is unavailable to establish the session conforming to the QoS request signal.
